(19) United States
(12) Patent Application Publication
(10) Pub. No.: US 2010/0245995 A1
(43) Pub. Date: Sep. 30, 2010

(54) PROJECTION SCREEN

(75) Inventors: Michael L. Graetz, Stillwater, MN (US); Mark L. Schuleman, Mendota Heights, MN (US); Thomas R. Gehring, Mahtomedi, MN (US); Andrew J. Piepel, Hudson, WI (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/597,282

(22) PCT Filed: Apr. 23, 2008
(86) PCT No.: PCT/US2008/061253

§ 371 Date: May 13, 2010

Related U.S. Application Data
(60) Provisional application No. 60/916,492, filed on May 7, 2007.

(51) Int. Cl. G03B 21/60; G03B 21/56; B32B 37/02

(52) U.S. Cl. 359/450; 359/443; 359/454; 359/455; 359/460; 156/152

(57) ABSTRACT

A projection screen for use in a projection system that includes an image source, such as a projector, is substantially flexible. In one embodiment, the projection screen includes a film to provide stiffness to the projection screen. In some embodiments, the film may be substantially self-supporting, thereby allowing for easier manipulating of the projection screen, such as when the projection screen is coupled to an application surface. In other embodiments, the projection screen includes a repositionable adhesive. The repositionable adhesive aids the coupling of the projection screen to a desired position on the application surface. For example, a user may couple the projection screen to the application surface in a first position, and, while the projection screen is still coupled to the application surface, adjust the position of the projection screen to a second position, such as by sliding the projection screen between the first and second positions.

### TECHNICAL FIELD

The invention relates to optical systems, and, more particularly, to projection screens for use in projection systems.

### BACKGROUND

Projection display systems typically include an image source, such as a projector, and a projection screen. During operation of the projection display system, the projector typically projects an image onto the projection screen for presentation to viewers. The projection screen may provide a diffuse surface to improve the image quality seen by viewers. A rear projection system may include an image source, optics to enlarge and direct the image light, and a projection screen to receive the image light from one side and transmit the images for viewing from the opposite side of the rear projection screen. A rear projection screen may be a sheet-like optical device with a relatively thin viewing layer that is placed at an image surface of the projector. Projection screens are often constructed of rigid materials such as glass or a semi-rigid, transparent polymeric material. As a result, it may be difficult to conveniently store an inflexible projection screen, e.g., because of an inability to roll the inflexible projection screen in the fashion that a diploma or map may be rolled without damaging the screen.

Projection systems may be used for advertising in malls, showrooms, and exhibitions. Rear projection systems are one such example. They consist of at least a projection device (e.g., a three-color liquid crystal display projector that combines polarized light from different liquid crystal displays and emits combined light to form images) and a rear projection screen. Typically, the projector is installed on a floor or, alternatively, the ceiling. Installation of floor or ceiling mounted systems requires significant resources. Complicated or time consuming installation procedures contribute to the cost of the system. While self-contained rear projection systems are available, such self-contained rear projection systems typically include bulky framework and housing elements that render the systems difficult to reposition. In addition, relatively large projection screens also tend to be quite heavy, further contributing to difficulties associated with transporting and installing the projection system.

### SUMMARY

In general, the invention is directed toward a substantially flexible projection screen. In some embodiments, the projection screen includes a film to provide stiffness to the projections screen, while maintaining the flexibility of the screen. For example, the film may be substantially self-supporting, thereby allowing for easier manipulating of the projection screen, such as when the projection screen is coupled to an application surface. The increased stiffness of the substantially flexible screen may help the user apply the screen to the application surface with greater accuracy, precision, and control.

Instead of or in addition to the stiffening film, in some embodiments, a substantially flexible projection screen includes a repositionable adhesive in order to help a user apply the screen to an application surface. For example, a user may couple the projection screen to the application surface in a first position, and, while the projection screen is still coupled to the application surface, adjust the position of the projection screen to a second position on the application surface. In one embodiment, the user may slide the projection screen relative to the application surface in order to set the screen in a desired position. In this way, a repositionable adhesive may increase the efficiency of the projection screen placement process because rather than requiring the user to completely remove the screen from the application surface in order to adjust the position, the repositionable adhesive truncates the process by allow the user to directly move from one position on the application surface to another position without removing the screen therefrom. Thus, the repositionable adhesive may help save time during a projection screen placement process.

The repositionable adhesive may be removable in some embodiments. Furthermore, the removable adhesive may be reusable in some embodiments. The repositionable adhesive aids the coupling of the projection screen to a desired position on the application surface.

In one embodiment, the invention is directed to a method comprising coupling a substantially flexible projection screen to a substantially transparent surface at a first position with a repositionable adhesive, where the flexible screen comprises a rear surface configured to receive light from a projector, a viewing surface opposite the rear surface, and a light absorbing layer for rendering the screen substantially opaque in ambient lit conditions when no image is projected on the screen by the projector. The method further comprises adjusting the screen relative to the substantially transparent surface from the first position to a second position without entirely uncoupling the flexible screen from the substantially transparent surface, and securing the screen to the substantially transparent surface at the second position with the repositionable adhesive.

In another embodiment, the invention is directed to a method comprising coupling a non-holographic, substantially flexible screen to a substantially transparent surface at a first position with a repositionable adhesive, where the screen comprises a rear surface for receiving light from a projector and a viewing surface opposite the rear surface, adjusting the screen relative to the substantially transparent surface from the first position to a second position without completely uncoupling the screen from the substantially parent surface, and securing the screen to the substantially transparent surface with the repositionable adhesive.

In another embodiment, the invention is directed to a projection screen for use in an optical system comprising a projector. The projection screen comprises a substantially flexible light transmitting substrate, light absorbing means associated with the light transmitting substrate for controlling ambient light rejection so that the screen appears substantially dark in ambient lit conditions when no light is projected on the screen from the projector, and a repositionable adhesive. The repositionable adhesive is configured to couple the screen to a substantially transparent surface in a first position so that viewers may view the screen through the substantially transparent surface. The repositionable adhesive is further configured to permit a user to move the screen from the first position to a second position relative to the substantially transparent surface without completely uncoupling the screen from the substantially transparent surface.

In another embodiment, the invention is directed to an optical system comprising a projector for presenting an image, and a screen comprising a rear side for receiving light from the projector and a viewing side opposite the rear side, the screen being adapted to receive an image from the projector from the rear side of the screen and present it to a viewer from the viewing side of the screen. The screen comprises light absorbing means for absorbing ambient light, and a repositionable adhesive configured to couple the screen to the substantially transparent surface in a first position so that viewers may view the screen through the substantially transparent surface. The repositionable adhesive is further configured to permit a user to move the screen from the first position to a second position relative to the substantially transparent surface without completely uncoupling screen from the substantially transparent surface.

In another embodiment, the invention is directed to a projection screen comprising a first surface, a second surface opposite the first surface, and an array of refractive elements. The refractive elements are substantially surrounded by an opaque matrix and exhibit a refractive index in the range of 1.4 to 2.0, and wherein the opaque matrix defines an army of apertures. The projection screen further includes a repositionable adhesive configured to couple the screen to an application surface in a first position, where the repositionable adhesive is further configured to permit a user to move the screen from the first position to a second position relative to the application surface without completely uncoupling screen from the application surface. The screen exhibits a mechanical flexibility sufficient to allow it to be rolled up into a cylindrical roll having an inner diameter of 15.25 centimeters (6 inches) or less, and an attachment member associated with at least one of said first and said second sides of said screen.

In another embodiment, the invention is directed to a method comprising selecting an application surface for application of a substantially flexible projection screen and coupling the projection screen to the application surface with the adhesive. The projection screen comprises a substantially flexible light transmitting substrate, light absorbing means associated with the light transmitting substrate for controlling ambient light rejection so that the screen appears substantially dark in ambient lit conditions when no light is projected on the screen from the projector, a substantially flexible film comprising a stiffness greater than the substantially flexible light transmitting substrate, and an adhesive configured to couple the screen to the application surface.

In another embodiment, the invention is directed to a projection screen comprising a substantially flexible light transmitting substrate, light absorbing means associated with the light transmitting substrate for controlling ambient light rejection so that the screen appears substantially dark in ambient lit conditions when no light is projected on the screen from the projector, a substantially flexible film comprising a stiffness greater than the substantially flexible light transmitting substrate, and an adhesive configured to couple the screen to an application surface.

In another embodiment, the invention is directed to an optical system comprising a projector for presenting an image and a screen comprising a rear side for receiving light from the projector and a viewing side opposite the rear side, the screen being adapted to receive an image from the projector from the rear side of the screen and present it to a viewer from the viewing side of the screen. The screen comprises a substantially flexible light transmitting substrate, light absorbing means associated with the light transmitting substrate for controlling ambient light rejection so that the screen appears substantially dark in ambient lit conditions when no light is projected on the screen from the projector, a substantially flexible film comprising a stiffness greater than the substantially flexible light transmitting substrate, and an adhesive configured to couple the screen to an application surface.

In another embodiment, the invention is directed to a projection screen comprising a first surface, a second surface opposite the first surface, and an array of refractive elements. The refractive elements are substantially surrounded by an opaque matrix and exhibit a refractive index in the range of 1.4 to 2.0, and wherein the opaque matrix defines an army of apertures. The projection screen further includes a substantially flexible light transmitting substrate and a substantially flexible film comprising a stiffness greater than the substantially flexible light transmitting substrate. The light transmitting substrate is positioned between the array of refractive elements and the film. The screen exhibits a mechanical flexibility sufficient to allow it to be rolled up into a cylindrical roll having an inner diameter of 15.25 centimeters (6 inches) or less, and an attachment member associated with at least one of said first and said second sides of said screen.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic diagram illustrating an optical system for displaying information to a viewer.

FIG. 2 is a schematic side view of an example of an optical system in which a substantially flexible projection screen in accordance with the present invention may be incorporated.

FIG. 3 is a schematic perspective view of another example of an optical system that includes a substantially flexible projection screen in accordance with the present invention.

FIG. 4 is a schematic side view of a projection screen according to an embodiment of the present invention, where the screen includes a substantially self-supporting film.

FIG. 5 is a schematic side view of another embodiment of a projection screen, which includes a repositionable adhesive.

FIG. 6 is a schematic side view of another embodiment of a projection screen, which also includes a repositionable adhesive.

FIG. 7 is a schematic side view of another embodiment of a projection screen, which is substantially similar to the projection screen of FIG. 4, but includes a performance enhancing layer.

FIG. 8 illustrates a schematic side view of another embodiment of a projection screen, which includes a Fresnel lens.

FIG. 9 is a schematic drawing of a projection screen with a border.

FIG. 10 is a plan view of a microstructured adhesive of a projection screen, where the adhesive defines channels to aid fluid bleed from between the projection screen and an application surface.

FIG. 11 is a flow diagram illustrating technique for coupling a projection screen including a repositionable adhesive to an application surface.

### DETAILED DESCRIPTION

FIG. 1 is a schematic diagram illustrating an optical system 10 for displaying information 12 to viewers 14. Viewers 14 may be, for example, an audience, spectators, pedestrians, potential customers, drivers, passengers, students, patrons or listeners. Optical system 10 includes screen 16 and projector 18. Projector 18 presents information 12, such as an image, to viewer 14 via screen 16. The image may be any suitable form of information such as textual data, video, still pictures or graphics. Information 12 provided to the customer may comprise a wide variety of information useful to communicate to a viewer such as a potential customer.

Optical system 10 may be useful for displaying information 12 for various purposes, such as, but not limited to, providing a warning, entertainment, promoting sales, presenting advertisements, presenting educational information, presenting announcements, promotions, displaying instructional information, and presenting or otherwise communicating other types of information. For example, optical system 10 may be useful for displaying information in high traffic areas such as airports, train stations, highways, banks, shops, cafes, ports, malls, shopping centers, trade shows, sports centers, convention centers, entertainment complexes, pubs, roads, grocery stores, entertainment centers, restaurants, securities companies, bars, nightclubs, bistros, retail outlets, auto dealerships, markets, convenience stores, CD stores, entertainment pavilions, bike trails, travel agencies, banks, bookstores, hardware stores, warehouses, franchises, tourist attractions, and trading exchanges. Optical system 10, however, is also useful in many other situations, and is not limited to use in high traffic areas.

Projector 18 may be any suitable rear-projection device. A wide variety of projectors may be used with a screen in the invention, including liquid crystal display (LCD) projectors, cathode ray tube (CRT) projectors, Digital Light Processing Projectors (DLP projectors), D-ILA projectors, and plasma projectors. Specific examples of suitable projectors include Digital Light Processing Projectors available from Texas Instruments DLP Technologies, Barco Projection Systems, Epson, Hitachi, JVC, Kodak, NEC, Panasonic, Philips, Polaroid, Sanyo, Sharp, Sony, and Toshiba. Specific model numbers include a Barco 6000 Series video projector, a Panasonic PT-D 9500 DLP-projector (capable of providing 10,000 ANSI lumens) and a Toshiba LCD Data Projector, number TLP 710. It is also contemplated that an overhead projector may be used in some aspects of the invention.

Screen 16 is a substantially flexible projection screen that defines a viewing surface for presenting information. In one embodiment, screen 16 is a rear projection screen and defines a rear surface for receiving light from projector 18, and a viewing surface opposite the rear surface. In other embodiments, screen 16 may be a front projection screen in which the viewing surface both receives light from projector 18 and presents the information to viewers 14. The flexible characteristic of screen 16 may allow screen 16 to be manipulated to define a smaller “foot print” (i.e., a more compact size) as compared to an unrolled screen 16 for relatively easy storage and transportation. Screen 16 is shown in an unrolled state in FIG. 1. In one embodiment, screen 16 may be rolled in a cylindrical fashion without damaging screen 16. “Cylindrical fashion” may include, for example, a manner in which maps, posters or diplomas are commonly rolled.

In some cases, public information displays may be changed, or removed completely, at relatively frequent intervals. As a result, components of such displays may need to be removed from the display site and stored for later use, or discarded and replaced at a later time. Screen 16 is useful for storing in relatively limited storages spaces because screen 16 is substantially flexible, permitting screen 16 to be rolled up or otherwise manipulated into a smaller foot print. For example, as described above, in one embodiment, screen 16 may be rolled into a relatively tight cylindrical configuration, such as a roll having a diameter of eight inches or less, depending on the size of screen 16. In this way, screen 16 may be placed, for example, in a protective tube or another protective housing during storage and/or transportation. In addition, rolling screen 16 during storage may help limit damage to screen 16 during handling (e.g., during shipping of screen 16).

Screen 16 is coupled to a substantially transparent application surface 20. In the embodiment shown in FIG. 1, screen 16 may be placed on any substantially transparent surface as long as it is in a position capable of being viewed by the potential customer 14. The substantially transparent surface may comprise, for example, exterior or interior doors or windows. In some cases, substantially transparent surface 20 may be somewhat opaque. For example, the surface may comprise a tinted, dirty or colored window, or it may comprise a window that has a wire pattern embedded in the glass. For a window with framing or other opaque portions, flexible screen 16 may be sized during installation to customize it for use with a particular shape of a window. In addition, flexible screen 16 is substantially conformable. That is, flexible screen 16 may readily change shape to substantially conform to the shape/configuration of a substrate (e.g., an application surface, such as substantially transparent surface 20 shown in FIG. 1) with an uneven, irregular or slightly curved surface. Furthermore, screen 16 may be cut into certain shapes or sizes to define various shapes and/or be customized to fit onto specific application surfaces.

Screen 16 is removably attached to substantially transparent surface 20, rather than substantially permanently attached to surface 20, which allows screen to be removed from surface 20 without substantially damaging surface 20 or resulting in excessive residue or adhesive transfer from screen 16 to transparent surface 20. In contrast, a permanent adhesive would substantially permanently adhere screen 16 to the transparent surface 20 and render screen 16 very difficult to remove from the surface 20 without substantially damaging surface 20 or leaving excessive residue or adhesive transfer on surface 20 after removal of screen 16. Removable attachment of screen 16 to surface 20 affords a temporary, secure attachment of screen 16 to transparent surface 20 while affording convenient, manual removal of the screen 16 from surface 20. While projection screens including removable adhesives are referred to throughout the remainder of the disclosure, in other embodiments, a screen in accordance with the invention may be attached to surface 20 via a permanent adhesive, such as a permanent adhesive that may be repositioned a limited number of times prior to exhibiting the permanent adhesive characteristics.

Screen 16 including a removable adhesive is useful for displaying information associated with impermanent events (as opposed to permanent events), special events (e.g., a farewell tour of a popular rock band), highly publicized marketing or promotional campaigns, high profile proceedings, advertising intended to briefly hype goods or services, fleeting sales or specials, and other transitory events.

Screen 16 may be coupled (or “associated”) to surface 20 via a removable adhesive that is disposed on the viewing surface of screen 16 (i.e., the surface of screen 16 facing viewers 14). The adhesive is designed to adhere screen 16 directly or indirectly to substantially transparent surface 20 (e.g., a window, wall, windshield, partition, table or door) so that viewers 14 may look through the window and see information 12 presented on screen 16 via projector 18. In addition, in some embodiments, the adhesive is an optical adhesive that allows a viewer to see through the adhesive without substantial degradation of the image quality or light transmission. Furthermore, in some embodiments, the adhesive may be a diffuse adhesive or a tinted adhesive.

Examples of removable adhesives are disclosed in U.S. Pat. Nos. 3,691,140, 4,166,152, 4,968,562, 4,994,322, 5,296,277, and 5,362,516 (the entire contents of which are herein incorporated by reference). In some embodiments, the removable adhesive is configured such that the necessary removal force to remove screen 16 from a glass window is about 20 grams to about 5.0 pounds force per lineal inch. For example, in one embodiment, the removal force for removing screen 16 from a glass window is about 0.5 to about 2.0 pounds force per lineal inch.

In embodiment in which screen 16 is removably attached to a surface, screen 16 is particularly useful for providing information to potential customers temporarily or during a predetermined time period. For example, an automobile dealership may wish to temporarily display advertising during a short time period to promote a fleeting bargain and generate excitement with consumers. Alternatively, a new place of business may wish to attract attention to a grand opening sale. In another embodiment, a centrally managed business may desire to engage in a transient marketing program designed to temporarily promote a good or service.

In some embodiments, the removable adhesive is a reusable adhesive. The reusable adhesive affords a temporary, secure attachment of the screen 16 to transparent surface 20 while affording convenient removal of screen 16 from transparent surface 20 without substantially damaging the transparent surface 20 or adjacent surfaces, or exhibiting excessive adhesive transfer from screen 20 to transparent surface 20. In addition, the reusable adhesive affords subsequent reuse of screen 16 (e.g., on another transparent surface). As yet another advantage, a reusable adhesive may allow a position of screen 16 to be adjusted on transparent surface 20. For example, if a user adheres screen 16 to transparent surface 20, but subsequently decides to adjust the initial position of screen 16, the reusable/repositionable adhesive may allow the user to disengage screen 16 from surface 20 and reattach screen 16 to surface 20 in another position until a screen 16 is in a desired position.

The reusable adhesive may be washable. A “washable: adhesive is an adhesive that can be treated by an appropriate cleaning solution (such as water or soap and water) to remove materials detrimental to an adhesive, thereby at least partially refreshing the adhesion of a used surface. After a number of uses, the adhesive may become dirty or otherwise detackified. Washing of washable adhesives removes materials that detract from the adhesion performance of the surface, and refreshes the surface for additional uses of screen 16.

In some embodiments, the adhesive is a repositionable adhesive, which may also, but need not be, be a removable and/or reusable adhesive in some embodiments. The repositionable adhesive permits a user to move screen 16 relative to application surface 20 without entirely removing screen 16 therefrom. Foe example, a user may initially engage screen 16 with surface 20 and move screen 16, such as by “sliding” screen 16 along transparent surface 20, from the initial position to another position without removing screen 16 from transparent surface 20. In some embodiments, when screen 16 is initially placed on surface 20, screen 16 may not be adhered to surface 20, and a user may need to manually hold screen 16 against surface 20. After screen 16 is in the desired position, user may apply pressure to screen 16 to engage the adhesive with surface 20 and secure screen 16 in place relative to surface 20.

In contrast to a strictly permanent or removable adhesive, a repositionable adhesive allows a user to reposition screen 16 relative to surface 20 without removing screen 16 from surface 20. If a user places a projection screen with a nonrepositionable adhesive on surface 20 and subsequently decides to move the screen, such as to align the screen with projector 18, the user may be required to remove the screen in order to reposition the screen. Depending upon the circumstances, the user may be required to remove the screen and replace the screen on the application surface numerous times, which may become time consuming A repositionable adhesive permits the user to place screen 16 on surface 20 at any position, and then subsequently slide screen 16 along surface 20 to the desired position without having to constantly remove screen 16 from surface 20 and reapply screen 16 to surface 20.

The repositionable adhesive permits the user to apply screen 16 to surface 20 with greater precision and accuracy as compared to non-repositionable adhesives. As an example, screen 16 that remains on surface 20 provides a reference point for determining the amount and/or direction screen 16 should be moved in order to correctly position screen 16 (e.g., in the desired position). That is, if the user is required to remove screen 16 from surface 20 in order to change the position of screen 16, the user may not correctly remember what the initial position of screen 16 was, and therefore, where the new position of screen 16 is relative to the previous position. The lack of the reference point may hinder the reapplication process of screen 16 to surface 20.

In other embodiments, the repositionable adhesive exhibits a single level of adhesion that both provides sufficient adhesive properties to allow screen 16 to be coupled to surface 20 without the aid of the user or other attachment mechanisms and enables the user to slide screen 16 along transparent surface 20 between two positions without removing screen 16 from transparent surface 20.

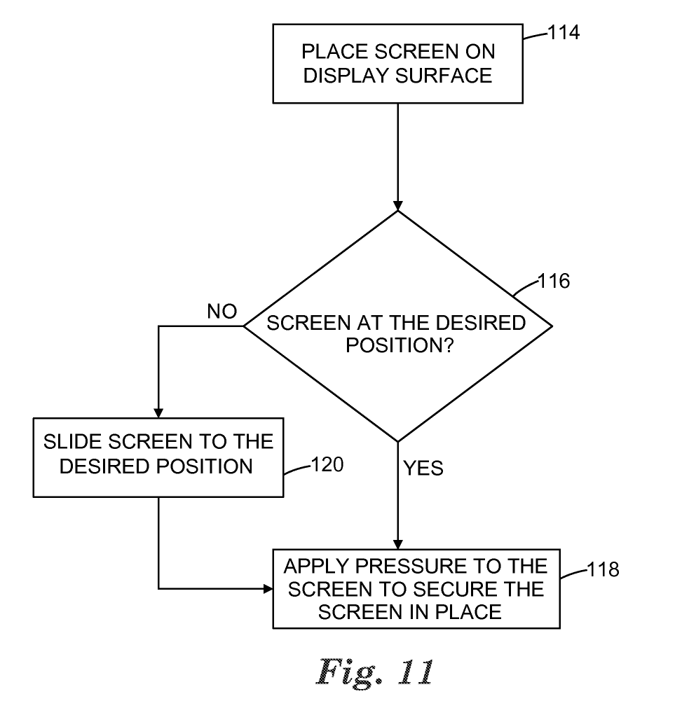

Screen 16 may include different adhesive layer configurations. In one embodiment, the adhesive preferably covers substantially all of the viewing surface side of screen 16 to provide a substantially uniform optical coupling of screen 16 to transparent surface 20. In such instances, it may be useful to use an adhesive with special features to address the problem of entrapped air between the screen and substrate. Suitable adhesives are believed disclosed in U.S. Pat. No. 6,197,397 and PCT Publication No. WO 00/56556 (the entire contents of both of which are incorporated by reference). An embodiment of a rear projection screen including an adhesive with a microreplicated topography (also known as a microstructured adhesive) is shown and described below with reference to FIG. 11.

In another embodiment, only portions of the viewing surface of screen 16 are coated with an adhesive. The adhesive may be arranged in a plurality of stripes, triangles, polymeric patterns or another pattern. While the adhesive is preferably an optical adhesive, it should be noted that non-optical adhesives may be used, particularly when the adhesive does not cover the entire surface of the screen. For example, with large screens where small imperfections in the screen may not be as apparent to a viewer, a few imperfections resulting from a non-optical adhesive may be more easily tolerated. An opaque adhesive may even be used as a border to help expedite installation of the screen as described in more detail below.

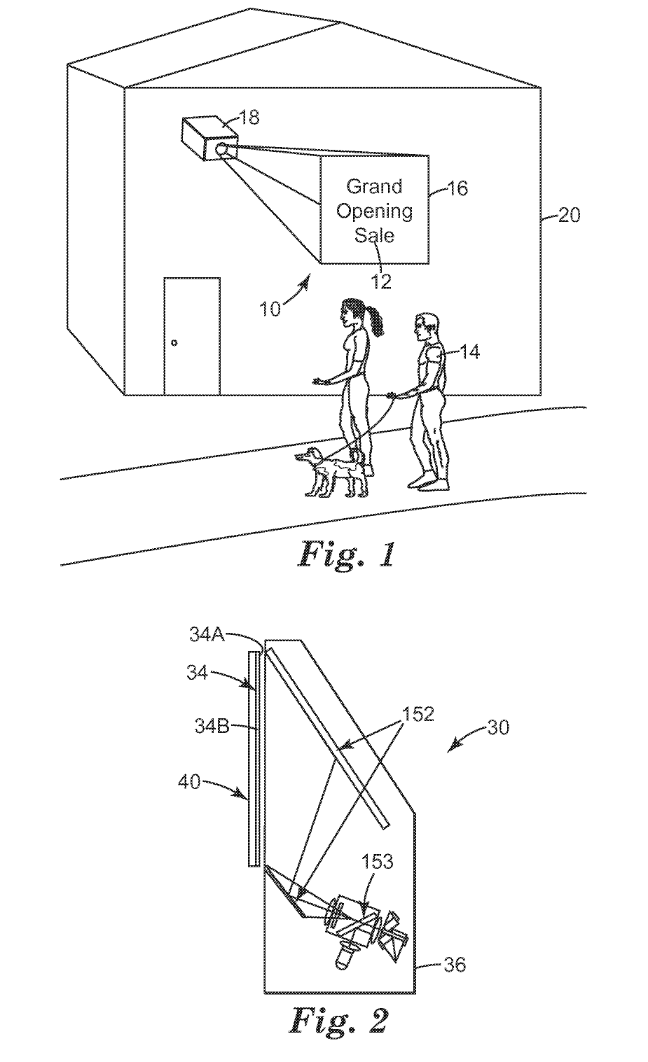

FIG. 2 is a schematic side view of an example of an optical system in which a projection screen in accordance with the present invention may be incorporated. Optical system 30 includes projector 32, screen 34, frame 36, and mirrors 38. In other embodiments, optical system 30 does not include mirror 38, and may be, for example, a single lens projector. During operation of optical system 30, projector 32 projects an image toward screen 34. Screen includes rear surface 34A, which receives light originating from projector 32, and a front surface 34B substantially opposite rear surface 34A. Front surface 34B is the “viewing” side of screen 34, and an image projected by projector 32 may be viewed from front surface 34B of screen 34. Screen 34 is temporarily attached to a substantially transparent surface, such as window 40. A viewer may looks at window 40 and see the image provided by optical system 30.

In one embodiment, screen 34 comprises a rear projection screen such as a beaded screen. Other screens are also contemplated for use with the present invention including diffusion screens. For example, the optical system may include a Fresnel lens and/or a lenticular lens or sheet as described in or constructed in accordance with U.S. Pat. Nos. 3,712,707, 3,872,032, 4,379,617, 4,418,986, 4,468,092, 4,509,823, 4,576,850, and 5,183,597 (the entire contents of which are herein incorporated by reference). Screens that use significant refraction to achieve a desired viewing angle are preferred.

Projector 32 and mirrors 38 may be pre-installed in the frame 36, such as at a remote, centralized location such as a warehouse or factory. In this embodiment, to install optical system 30 at a place of business, a user may adhere screen 34 to window 40 and then position frame 36 proximate to window 40. In this way, a preassembled projector 32 and mirror 38 assembly may simplify installation and removal of optical system 30.

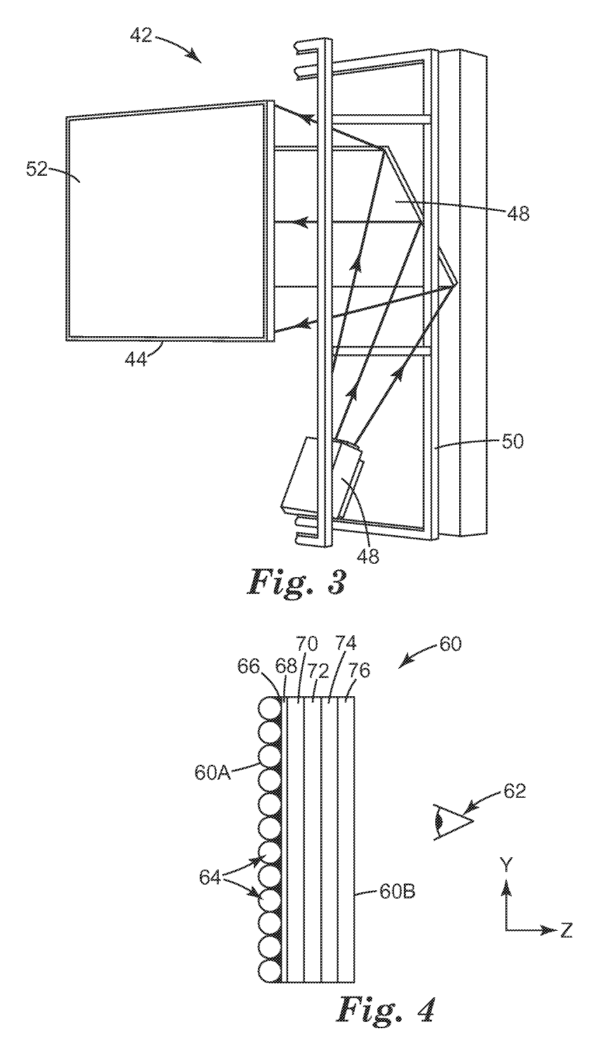

FIG. 3 is a schematic perspective view of another example of optical system 42 that includes flexible screen 44 in accordance with the present invention. Optical system 42 further includes projector 46, one mirror 48, and an adjustable frame and stand system 50. Screen 44 is adapted to be coupled to window 52. Adjustable frame and stand system 50 accommodates the use of different projectors 46 in optical system 42. For example, an on-axis projector may be used with a first promotional campaign. Thereafter, the on-axis projector may be replaced with an off-axis projector for a second promotional campaign having different video requirements.

FIG. 4 is a schematic side view of screen 60 according to an embodiment of the present invention. A viewing eye 62 is schematically shown in FIG. 4 in order to provide a reference point for identifying a rear side 60A of screen, which faces away from viewing eye 62, and a front, viewing side 60B of screen 60, which faces viewing eye 62. Front side 60B is on an opposite side of screen 60 from the rear side 60A (also referred to as a “back side”). Screen 60 may be useful in rear projection optical systems, such as, but not limited to, systems 10, 30, and 42 of FIGS. 1-3, respectively.

Screen 60 includes a plurality of refractive elements 64 (e.g., glass beads), light absorbing layer 66, light transmitting substrate 68, adhesive 70, film 72, removable adhesive 74, and liner 76. In one embodiment, refractive elements 64 are situated in substantially predetermined positions. However, manufacturing and cost limitations may limit the precision of the placement of refractive elements 64. For example, refractive elements 64 may be placed in an array, a closely or loosely packed arrangement.

Refractive elements 64 may be constructed from glass or polymeric materials. Suitable examples include glass or a transparent plastic material. Projections screens including refractive beads and construction of such screens may comprise the teachings disclosed in commonly assigned patent applications PCT WO 99/50710 and PCT WO 98/45753, and U.S. Pat. No. 6,466,368, issued Oct. 15, 2002, and entitled “REAR PROJECTION SYSTEM WITH REDUCED SPECKLE,” and U.S. Pat. No. 6,535,333, issued Mar. 18, 2003, entitled “OPTICAL SYSTEM WITH REDUCED COLOR SHIFT”, U.S. Pat. No. 6,631,030, issued Oct. 7, 2003, and entitled “PROJECTION SCREENS AND METHODS FOR MAKING SUCH PROJECTION SCREENS,” and U.S. Pat. No. 6,204,971, issued Mar. 20, 2001 and entitled “GLASS MICROSPHERES FOR USE IN FILMS AND PROJECTION SCREEN DISPLAYS AND METHODS” (the entire contents of each of which are herein incorporated by reference).

In one embodiment, refracting elements 64 are transparent, substantially spherical, refracting beads seated in an absorptive, high optical density transparent polymer matrix. The beads may be in intimate contact with the transparent binder material. The beads may have a refractive index between about 1.2 and 1.9. In some embodiments, the spherical beads have an average diameter of greater than about 20 micrometers (μm) and less than about 400 μm. For example, the average diameter may be between about 40 μm and about 90 μm. As another example, the average diameter of the refractive beads may be is a range of about 50 μm and about 80 μm. In one embodiment, the average diameter of each spherical refractive bead is about 65 μm.

Screen 60 including refractive beads (i.e., a “beaded screen”) affords a relatively good contrast and a viewing angle that allow a bright, sharp picture to be viewed at wide angles while minimizing any losses in image quality due to washout from sunlight or room lighting. Beaded screens may be constructed to provide substantially symmetric horizontal and vertical viewing angle and gain characteristics. This may be particularly useful for large screens used in multilevel locations (such as shopping malls) where a person located on a level above or below the screen may wish to view the screen. Also, beaded screens may be constructed to be flexible so that they can be easily mounted to any rigid, transparent surface minimizing surface reflection losses that might be present with a conventional rigid rear projection screen.

Projection screens may be susceptible to loss of image contrast due to ambient light incident on the screen. Such ambient light effects can be suppressed by various means, including the use of refractive elements surrounded by an opaque, typically black, matrix of material. In screens of this type, the viewing angle can be varied by varying the refractive index of the refractive elements of the screen.

As used herein, the viewing angle means the angle at which gain is reduced by 50% of the peak value. To determine viewing angle, screen gain is tested. Gain is a measure of screen brightness and a function of viewing angle. It is normalized with respect to a Lambertian diffuser. To measure gain, a white light source illuminates a white reflectance standard. Its luminance is measured with a luminance meter at near normal incidence (L_{R}). A screen is placed in front of the light source and the luminance is measured (on the opposite side of the sample from the source) at near normal incidence (L_{S}). The peak gain is defined as the ratio of L_{S}/L_{R}. After the on-axis gain measurement, the screen then stepped through a range of angles, a luminance reading taken at each position. Lₛ−θ/L_{R} (Gain) is then plotted as a function of angle. The viewing angle is defined as the angle at which the gain falls to one-half its peak value.

When beaded rear projection screens are used for displays, it has been found that in some situations, a wider viewing angle is desired, while in other situations, a narrower viewing angle may be preferred. Lower refractive indices for the beads tend to narrow the viewing angle, but provide a brighter image to viewers located within the area defined by the maximum viewing angle. For this reason, it is useful to be able to provide a variety of different screens for different situations. Use of different beads for different screens affords this flexibility in screen design.

In one embodiment, light absorbing layer 66 may be coated on or otherwise coupled to light transmitting substrate 68. In another embodiment, light transmitting substrate 68 may be applied onto light absorbing layer 66. Light absorbing layer 66 helps controls ambient light rejection for an optical system. As a result of light absorbing layer 66, screen 60 supplies excellent contrast characteristics, even in relatively high ambient lighting conditions, as compared to screens that do not include a light absorbing layer 66. The contrast characteristics of screen may be described in terms of ambient light contrast ratio (ALCR), which is a ratio of the brightness of a white image to a black image and depends on the ability of a screen to absorb the ambient light. A testing assembly for measuring ALCR is described in commonly-assigned U.S. Pat. No. 6,870,670, entitled, “SCREENS AND METHODS FOR DISPLAYING INFORMATION,” which issued on Mar. 22, 2005, the entire content of which is incorporated herein by reference. In embodiments in which refractive elements 64 are glass beads, the glass beads help attribute a relatively high level of contrast performance in high ambient light conditions, i.e., a relatively high ALCR. In one embodiment, refractive elements 64, light absorbing layer 66, and light transmitting layer 68 are defined by an XRVS Beaded Screen, which is available from Minnesota Mining and Manufacturing Company of St. Paul, Minn., and exhibit an ALCR in a range of greater than about 25 to about 75 for ambient light of about 500 lux.

Light absorbing layer 66 may be opaque or substantially opaque. In embodiments, light absorbing layer 66 includes one or more of a powder coating of carbon black, a black dye, an opaque particle, an organic or inorganic pigment or particle, or such a particle dispersed in a binder material. The particles that define light absorbing layer 66 may be of a wide variety and shapes. For example, the material may be dispersed in a liquid or solid binder system. In one embodiment, light absorbing layer 66 comprises a clear binder having black particles dispersed throughout the clear binder. The binder may comprise, for example, an acrylate or other UV curable polymer. Light absorbing layer 66 may be applied by a conventional technique such as a coating process or powder coating.

Light transmitting substrate 68 is substantially flexible to help render screen 60 substantially flexible. Light transmitting substrate 68 is also substantially transparent or translucent. For example, a substantially flexible and substantially transparent substrate 68 may comprise suitable light transmitting materials such as polyvinyl chloride, acrylic, polycarbonate or combinations of such materials. Light transmitting surface 68 may include an optional matte anti-glare finish, such as a finish achieved by embossing.

Screen 60 further includes adhesive 70, which may be, for example, a pressure sensitive adhesive. In one embodiment, adhesive 70 is an optical adhesive. Optical adhesives that are believed to be suitable are disclosed in PCT WO 97/01610 (the entire contents of which are herein incorporated by reference). Adhesive 70 couples light transmitting substrate 68 to film 72, and accordingly, adhesive 70 need not necessary exhibit removable, reusable, or repositionable properties. Adhesive 70 may be applied using a variety of techniques known to those skilled in the art such as casting, extruding, coating, spraying, screen-printing and laminating.

Coating weights of adhesive 70 can range from about 10 μm to about 508 μm. For example, in one embodiment, adhesive 70 has a coating weight of about 20 μm to about 250 μm. Percent solids of such adhesives in the formulations to be applied on layer range from about 5% to about 100%, such as from about 20% to about 100%. In some embodiments, the refractive index (n) of adhesive 70 is between about 1.40 and about 1.9, such as between about 1.48 and about 1.50. In one embodiment, the index of refraction of adhesive 70 is substantially similar to the index of refraction of light transmitting substrate 68 so that a minimum amount of scattering occurs that may reduce the brightness or other optical properties of the screen. In some embodiments, the difference in the indexes of refraction Δn (i.e., Δn=n_{ADHESIVE}−n_{SUBSTRATE}) is less than about 0.15 more preferably 0.1 or less. Alternatively, other factors may be varied to achieve the desired effect.

Film 72 provides integrity to screen 60. Film 72 is stiffer than light transmitting layer 68. In some embodiments, film 72 is substantially self-supporting, which allows film 72 to define a substantially planar surface without the aid of additional support structures. However, the extent to which film 72 is substantially self-supporting may depend upon the size of screen 60 because film 72 may only be configured to support a certain amount of weight, thus limiting the extent to which it is self-supporting, and a larger screen 60 typically means greater weight. The extent to which film 72 is substantially self-supporting may depend upon the thickness of film 72, which is measured along the z-axis direction (orthogonal y-z axes are shown in FIG. 4). Accordingly, a thickness of film 72 may be adjusted to support different sized screens 60. In one embodiment, film 72 has a thickness measured along the z-axis direction in a range of about 0.254 mm to about 5 mm, such as about 4 mm. However, in other embodiments, film 72 may have any suitable thickness to help support the other elements of screen 60. A thickness of film 72, however, should be selected such that screen 60 remains substantially flexible, and such that screen 60 may be rolled-up or otherwise manipulated into a more compact size for storage and/or transportation.

In contrast to film 72, in some embodiments, refractive elements 68, light absorbing layer 66, and transmitting layer 68 are not substantially self-supporting and may fold over themselves without the aid of additional support structures. That is, refractive elements 68, light absorbing layer 66, and transmitting layer 68 may not be able to maintain a substantially planar configuration without the aid of additional support, such as an application surface or film 72. Thus, film 72 lends support and stiffness to at least refractive elements 68, light absorbing layer 66, and transmitting layer 68. The stiffness provided by film 72 may help a user control screen 60, such as when the user applies screen 60 to a surface (e.g., transparent surface 20 of FIG. 1). In some cases, such as when screen 60 is relatively large (e.g., greater than 1 meter (m)×1 m), screen 60 may be relative difficult to manipulate without film 72. For example, if screen 60 is relatively large, the user may not be able to hold/control all portions of the relatively large screen, which may make it difficult for the user to hold screen 60 relative flat against the application surface (e.g., a display surface). If, for example, the user is holding a bottom portion of the screen, the top portion may fold onto the bottom portion, thus making it difficult for the user to concurrently control the top and bottom portions, particularly when the screen is too large for the user to hold onto both the top and bottom portions. In addition, a flimsy screen (i.e., a screen without film 72) may make it difficult for the user to accurately and precisely position screen 60 on the application surface because of the flimsy screen may be difficult to control.

In general, the stiffness provided by film 72 may allow for easier handling of screen 60. For example, a user may be able to hold onto a bottom portion of screen 60 that includes film 72 and maintain control over both the bottom and top portions of screen 60. Film 72 may help prevent the top portion from folding onto the bottom portion. As previously described, however, although film 72 provides stiffness to screen 60, film 72 remains substantially flexible, thereby allowing screen 60 to be rolled-up or otherwise compacted for storage.

Just as with light transmitting substrate 68, film 72 is substantially transparent or translucent. For example, film 72 may comprise suitable light transmitting materials such as polyvinyl chloride, acrylic, polycarbonate, polyethylene terephthalate (PET), polyethylene terephthalate glycol (PETG), combinations of such materials or other substantially transparent and substantially flexible films. In some embodiments, film 72 has an index of refraction between about 1.40 and about 1.9, such as between about 1.48 and 1.50. Furthermore, in some embodiments, film 72 has an index of refraction that is substantially similar to light transmitting substrate 68 and adhesive. In some embodiments, the difference in the indexes of refraction Δn (i.e., Δn=n_{FILM}−n_{SUBSTRATE}) is less than about 0.15 more preferably 0.1 or less.

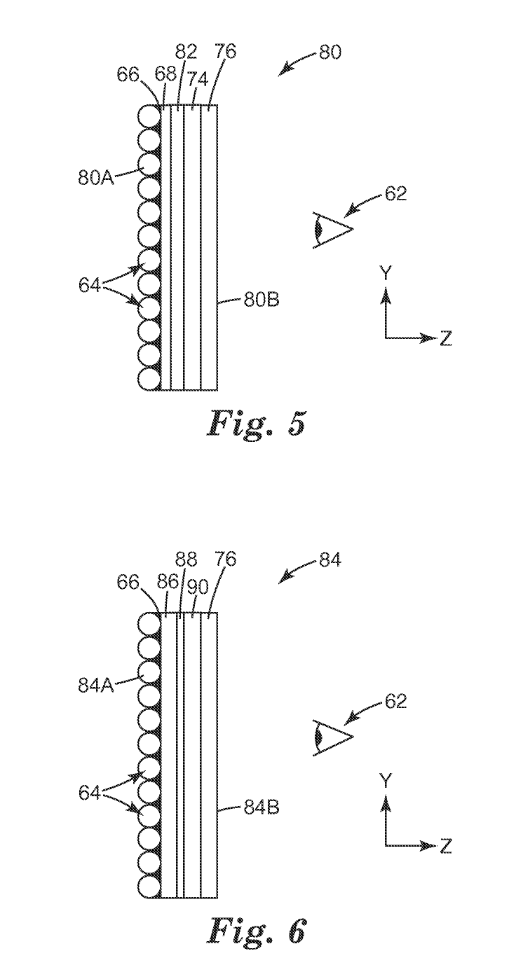

In addition to or instead of film 72, in some embodiments, screen 60 may include a repositionable adhesive 74 that may allow the user to accurately position the screen on a surface regardless of the lack of a stiffening film 72. As described below with reference to FIGS. 5-6, in some embodiments, a screen may only include the repositionable adhesive and may not include film 72.

Removable adhesive 74 couples screen 60 to an application surface, such as transparent surface 20 of FIG. 1. As previously described, removable adhesive 74 permits screen 60 to be removed from an application surface without substantially damaging the application surface or leaving undue adhesive residue behind on the application surface. In some embodiments, removable adhesive 74 is also a repositionable adhesive, which allows screen 60 to be moved relative to the application surface without completely removing screen 60 from the application surface. For example, screen 60 may be slidable relative to the application surface prior to applying pressure to adhesive layer 74 (i.e., by applying pressure to screen) to substantially secure screen 60 to the application surface.

In one embodiment in which adhesive 74 is a repositionable adhesive, adhesive 74 comprises a pressure-sensitive adhesive that includes a plurality of spaced clumps of particles substantially uniformly or randomly distributed over and protruding from the side of adhesive 74 that faces away from refractive elements 64. The tips of the clumps of particles are substantially free from the pressure-sensitive adhesive, thereby allowing screen 60 to move relative to an application surface when primarily the particles contact the application surface. After the user slides screen 60 to the desired position on the application surface, the user may apply pressure to screen 60 in order to break the clumps of particles and in some cases, push the clumps of particles into the pressure-sensitive adhesive, thereby bringing the pressure-sensitive adhesive into contact with the application surface and securing screen 60 to the application surface. In one embodiment, the individual particles are smaller than the thickness of adhesive layer 74 (measured along the z-axis direction) in order to help prevent the particles from being visible after being pressed into adhesive 74. For example, when the adhesive layer of the novel pressure-sensitive adhesive tape is about 25 μm in thickness, each of the particles is preferably less than about 20 μm in diameter, such as from about 5 μm to about 15 μm in diameter.

In some cases, however, some adhesive may contact the application surface in addition to the particles, thereby allowing screen 60 to partially adhere to the application surface. The partial adherence to the application surface may help a user maintain better control of screen 60 when repositioning screen 60.

The particles have a relatively low coefficient of friction with ordinary substrates such as glass, wood, and steel, thus permitting screen 60 to be slid across the substrate for easy repositioning. In one embodiment, the particles are substantially spherical in order to improve the slidability of screen 60. For example, the particles may be glass beads. Also useful and economical are ceramic, metallic, and polymeric particles. The particles can be slightly tacky as long as they do not form permanent bonds upon contacting ordinary substrates, but when they are slightly tacky, it might be necessary to lift the novel tape to reposition it. For example, the particles can be microspheres of adhesive such as those disclosed in U.S. Pat. No. 3,691,140 (Silver).

In one method of forming the repositionable adhesive 74, a carrier web, such as a craft paper with a thing, embossable polyethylene coating that is covered by a silicone release coating, is formed with a plurality of hemispherical or truncated-cone shaped depressions or dimples, and a large number of tiny particles are deposited into each of the dimples. Other carrier webs may include plasticized polyvinyl chloride, polypropylene or biaxially oriented PET. The carrier web is then covered with a pressure-sensitive adhesive and the adhesive is allowed to flow into intimate contact with some of the particles in each of the dimples.

Examples of microreplicated adhesives and methods of making the same are further described in commonly-assigned U.S. Pat. No. 6,197,397, entitled, “ADHESIVES HAVING A MICROREPLICATED TOPOGRAPHY AND METHODS OF MAKING AND USING SAME” and issued on Mar. 6, 2001, U.S. Pat. No. 6,524,679, entitled, “METHOD OF ENHANCING COATING SPEED,” and issued on Feb. 25, 2003, U.S. Pat. No. 6,803,072, entitled, “METHOD OF ENHANCING COATING SPEED,” and issued on Oct. 12, 2004, U.S. Pat. No. 5,141,790, entitled, “REPOSITIONABLE PRESSURE-SENSITIVE ADHESIVE TAPE,” and issued on Aug. 25, 1992, U.S. Pat. No. 5,296,277, entitled, “POSITIONABLE AND REPOSITIOANBLE ADHESIVE ARTICLES,” and issued on Mar. 22, 1994, U.S. Pat. No. 5,362,516, entitled, “METHOD OF PREPARING AN ADHESIVE ARTICLE,” and issued on Nov. 8, 1994, U.S. Pat. No. 5,795,636, entitled, “POSITIONABLE AND REPOSITIONABLE ADHESIVE ARTICLE,” and issued on Aug. 18, 1998, U.S. Pat. No. 6,123,890, entitled, “METHOD FOR MAKING PRESSURE-SENSITIVE ADHESIVE ARTICLES HAVING MICROSTRUCTURED SURFACES,” and issued on Sep. 26, 2000, U.S. Pat. No. 6,015,606, entitled, “ADHESIVE-COATED FILM,” and issued on Jan. 18, 2000, and U.S. Pat. No. 6,524,675, entitled, “ADHESIVE-BACK ARTICLES,” and issued on Feb. 25, 2003.” Further examples of microreplicated adhesives are described in PCT Publication No. WO 00/22059 (Hidetoshi), and PCT Publication No. WO 00/69985 (Mikami). The entire content of each of the foregoing U.S. patents and PCT publications are incorporated herein by reference.

In some embodiments, coating weights of adhesive 74 (i.e., a thickness of adhesive 74 measured along the z-axis direction) ranges from about 10 μm to about 300 μm. For example, the coating weight of adhesive 74 may range between about 20 μm and about 250 μm. Percent solids of such adhesives in the formulations to be applied on layer range from about 5% to about 100% and preferably from about 20% to about 100%. Adhesive 74 may be applied to film 72 or linear 76 using a variety of techniques known to those skilled in the art such as casting, extruding, coating, spraying, screen-printing and laminating.

In some embodiments, the refractive index of adhesive 74 is between about 1.40 and about 1.9, such as between about 1.4 and about 1.55. For example, in one embodiment, the index of refraction of adhesive 74 is close to the index of refraction of substrate 68 to minimize scattering, which may reduce the brightness or other optical properties of the screen. In some embodiments, the difference in the indexes of refraction of adhesive 74 and substrate 68 is less than about 0.15, and in other embodiments, the difference in the indexes of refraction is less than about 0.1. Alternatively, other factors may be varied to achieve the desired effect.

Screen 60 optionally includes liner 76 that is designed to be manually removed from screen 60 just prior to installation of the screen 60 on a window or another application surface. Liner 76 protects the viewing side 60B of screen 60 from damage, and helps prevent adhesive 74 from contamination prior to use of screen 60.

In one embodiment, film 72, removable adhesive 74, and liner 76 are comprised of Controltac adhesive system, which is available from Minnesota Mining and Manufacturing Co. of St. Paul, Minn.

Screen 60 may optionally be a disposable screen. For example, screens including refractive elements 64 are typically much less costly than a holographic screen. As a result, it may be convenient for a user to simply dispose of screen 60 after use. Another advantage of a beaded screen is that a flexible beaded screen may be conveniently tiled together to create a large format screen (e.g., greater than 100 inches in diagonal) without encountering the difficulties associated with attempting to tile together large area rigid screens.

FIG. 5 is a schematic side view of another embodiment of screen 80, which includes a plurality of refractive elements 64, light absorbing layer 66, light transmitting substrate 68, removable and repositionable adhesive 74, liner 76, and adhesion promotion layer 82. Refractive elements 64, light absorbing layer 66, light transmitting substrate 68, removable and repositionable adhesive 74, liner 76 are substantially similar to the like-numbered refractive elements 64, light absorbing layer 66, light transmitting substrate 68, removable and repositionable adhesive 74, and liner 76 of screen 60 of FIG. 4. Similarly, viewing eye 62 is schematically shown in FIG. 5 in order to provide a reference point for identifying a back side 80A of screen 80, which faces away from viewing eye 62, and a front, viewing side 80B of screen 80 opposite the back side 80A. Front side 80B faces toward viewing eye 62. Screen 80 may be useful in rear projection optical systems, such as, but not limited to, systems 10, 30, and 42 of FIGS. 1-3, respectively.

In contrast to screen 60 of FIG. 4, screen 80 includes adhesion promotion layer 82 and does not include film 72. Adhesion promotion layer 82 may include a primer. Adhesion promotion layer 82 helps provide a high level of adhesion between light transmitting substrate 68 and removable and repositionable adhesive 74. However, adhesion promotion layer 82 is optional and the inclusion of adhesion promotion layer 82 in screen 80 may depend upon the type of light transmitting substrate 68 that is used. Some substrates 68 may be more compatible with adhesive 74, thereby allowing for a stronger hold between substrate 68 and adhesive 74, while others may not, in which case adhesion promotion layer 82 may be desirable. If desired, a Corona treatment may be used to treat the surface of light transmitting substrate 68 to improve the bonding characteristics by increasing a surface energy of light transmitting substrate 68. The Corona treatment may be used in addition to or instead of adhesion promotion layer 82.

In order to help limit any adverse effects adhesion promotion layer 82 may have on screen 80, adhesion promotion layer 82 has an index of refraction that is substantially similar to the index of refraction of light transmitting substrate 68 and adhesive 74. The substantially similar indexes of refraction help minimize the amount of scattering, thus reducing any adverse affects on the brightness or other optical properties of screen 80. In some embodiments, the refractive index (n) of adhesion promotion layer 82 is between about 1.40 and about 1.9, such as between about 1.4 and about 1.55.

In one method of making screen 80, adhesive 74 may be applied to liner 76 using any suitable technique, such as casting, extruding, coating, spraying, screen-printing and laminating. Adhesion promotion layer 82 may be applied to adhesive 74 using any suitable one of the aforementioned techniques. Light transmitting substrate, light absorbing layer 66, and refractive elements 64 may then be applied to the adhesion promotion layer 82.

As previously described, film 72 helps provide integrity to screen 60, thereby allowing for easier handling of screen 60, such as when screen 60 is being coupled to an application surface. Although screen 80 does not include film 72, the coupling of screen 80 to an application surface may be less problematic as compared to projection screens that do not include a repositionable adhesive 74. Repositionable adhesive 74 permits the user to initially place screen 80 on an application surface at a position that is not necessarily the desired position. The user may then slide screen 80 along the application surface to the desired location without having to completely remove screen 80 from the application surface and replace screen 80 on the surface in the desired position. In contrast, with projection screens that include a nonrepositionable adhesive, the user may be required to place the screen on the application surface at the desired position the first time the screen is placed on the application surface, or else remove the screen in order to reposition the screen. Depending upon the circumstances, the user may be required to remove the screen and replace the screen on the application surface numerous times. The user may remove any air bubbles or fluid bubbles that are trapped between screen 80 and the application surface at any time, either before or after screen 80 is in the desired position on the application surface. For example, the use may use a roller tool that defines a substantially flat surface that may be pressed over screen 80 to remove the air bubbles.

FIG. 6 is a schematic side view of another embodiment of screen 84, which includes a plurality of refractive elements 64, light absorbing layer 66, high tack adhesive 86, adhesive carrier 88, low tack adhesive 90, and liner 76. Refractive elements 64 and light absorbing layer 66 are substantially similar to the like-numbered refractive elements 64 and light absorbing layer 66 of screen 60 of FIG. 4. Similarly, viewing eye 62 is schematically shown in FIG. 6 in order to provide a reference point for identifying a back side 84A of screen 84, which faces away from viewing eye 62, and a front, viewing side 84B of screen 84 opposite the back side 80A. Front side 84B faces toward viewing eye 62. Screen 84 may be useful in rear projection optical systems, such as, but not limited to, systems 10, 30, and 42 of FIGS. 1-3, respectively.

In one embodiment, light absorbing layer 66 may be applied to high tack adhesive 86, while adhesive 86 is coupled to at least adhesive carrier 88, via any suitable method, such as casting, extruding, coating, spraying, screen-printing and laminating. Thereafter, refractive elements 64 may be attached to light absorbing layer 66, as described above. In this way, high tack adhesive 86 may provide a support layer for refractive elements 64 and light absorbing layer 66. In the previous embodiments, substrate 68 provided the support layer for refractive elements 64 and light absorbing layer 66. A “support layer” is generally a layer of material that provides a surface on which refractive elements 64 and light absorbing layer 66 may be applied (e.g., by casting, extruding, coating, spraying, screen-printing, laminating or otherwise).

High tack adhesive 86 is substantially more tacky than low tack adhesive 90, which allows high tack adhesive 86 to provide a more permanent adhesion to refractive elements 64 and light absorbing layer 66. In contrast, low tack adhesive 90 is a removable and repositionable adhesive for applying onto an application surface. In this way, low tack adhesive 90 enables screen 84 to be removed from the application surface without causing substantial damage to the application surface, and also enables screen 84 to be moved relative to the application surface without removing screen 84 therefrom.

High tack adhesive 86 may have a thickness of about 0.01 mm to about 0.25 mm, such as about 0.025 mm. Low tack adhesive 90 may have a thickness of about 0.01 mm to about 0.25 mm, such as about 0.025 mm. In addition, high tack and low tack adhesives 86, 90 may be optical adhesives. In order to help limit any adverse effects high tack and low tack adhesives 86, 90 may have on screen 84, high tack and low tack adhesives 86, 90 may each have an index of refraction that is substantially similar to the index of refraction of light transmitting substrate 68. In some embodiments, the refractive index (n) of each of high tack and low tack adhesives 86, 90 is between about 1.40 and about 1.9, such as between about 1.4 and about 1.55.

In addition to providing some integrity to screen 84, adhesive carrier 88 helps separate high tack adhesive 86 from low tack adhesive 90. Adhesive carrier 88 may be formed at least in part of, for example, PET, polyvinyl chloride, acrylic, polycarbonate or combinations of such materials. In some embodiments, adhesive carrier 88 may have a thickness (measured along the z-axis direction) of about 0.025 mm to about 2 mm. For example, in one embodiment, adhesive carrier 88 has a thickness of about 0.10 mm. Adhesive carrier 88 is substantially flexible to help lend flexibility to screen 84. Just as with light transmitting substrate 68 (FIGS. 4-5), adhesive carrier 88 is substantially transparent or translucent. For example, a substantially flexible and substantially transparent substrate 68 may comprise suitable light transmitting materials such as polyvinyl chloride, acrylic, polycarbonate or combinations of such materials.

In some embodiments, high tack adhesive 86, adhesive carrier 88, and low tack adhesive 90 may be provided by a 9425 Repositionable Tapes or another Repositionable Tape made available by Minnesota Mining and Manufacturing Co. of St. Paul, Minn.

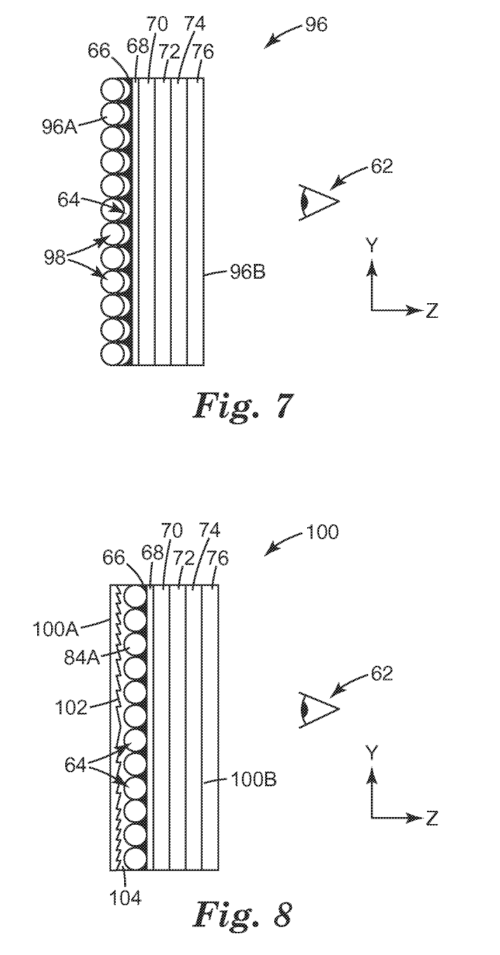

FIG. 7 illustrates a schematic side view of another embodiment of a screen 96, which is substantially similar to screen 60 of FIG. 4. However, screen 96 includes performance enhancing layer 98. Performance enhancing layer 98 may comprise a hard coat, an anti-static coating, anti-scuff coating or combinations thereof. Such coatings may be included to help protect screen 96 and to render screen 96 cleanable. The ability to clean screen 96 is particularly useful for a screen that has a reusable adhesive and that is designed to be reused. In some embodiments, performance enhancing coating 98 is a coating described in U.S. Pat. No. 6,466,368, issued Oct. 15, 2002, and entitled “REAR PROJECTION SYSTEM WITH REDUCED SPECKLE,” and U.S. Pat. No. 6,535,333, issued Mar. 18, 2003, and entitled “OPTICAL SYSTEM WITH REDUCED COLOR SHIFT” (the entire contents of each of which were previously incorporated by reference).

Screen 96 defines a back side 96A and viewing side 96B substantially opposite back side 96A. Screen 96 includes an array of refractive elements 64, light absorbing layer 66, light transmitting substrate 68, adhesive 70, film 72, optical adhesive 74, and optional releasable liner 76. As previously described, the substantially transparent, substantially spherical, refracting elements 64 are preferably seated in an absorptive, high optical density polymer matrix and are in intimate contact with the transparent binder material.

FIG. 8 illustrates another embodiment of screen 100, which is substantially similar to screen 60 of FIG. 4. However, screen 100 differs from screen 60 because screen 100 includes a Fresnel lens 102 incorporated near the rear surface of refractive elements 64 with an adhesive 104. Adhesive 104 may be affixed at the edge of screen 100, leaving an air gap between the surface of Fresnel lens 102 closest to refractive elements 64. In some embodiments, Fresnel lens 102 may be constructed in accordance with the disclosures in one or more of U.S. Pat. Nos. 3,712,707; 3,872,032; 4,379,617; 4,418,986; 4,468,092; 4,509,823; 4,576,850 and 5,183,597 and published Japanese document nos.: 64-86102 assigned to DAINIPPON PRINTING CO. LTD. (publication date Mar. 30, 1998); 63-134227A assigned to DAINIPPON PRINTING CO. LTD. (publication date Jun. 6, 1988) and 5-119205 assigned to DAINIPPON PRINTING CO. LTD. (publication date May 18, 1993) (the entire contents of each of which are herein incorporated by reference). Alternatively, a light refracting film (e.g., Transmissive Right Angle Film available from Minnesota Mining and Manufacturing Company of St. Paul, Minn.) may be used instead of or in conjunction with the Fresnel lens 102 to afford a more convenient location of the projector relative to the screen.

In other embodiments of any of the previous projection screens 60, 80, 84, 96 of FIGS. 4-7, respectively, may include a Fresnel lens. Furthermore, in other embodiments of any of the previous projection screens 60, 80, 84, and 100 of FIGS. 4-6 and FIG. 8, respectively, may include a performance enhancing coating 98 (FIG. 7).

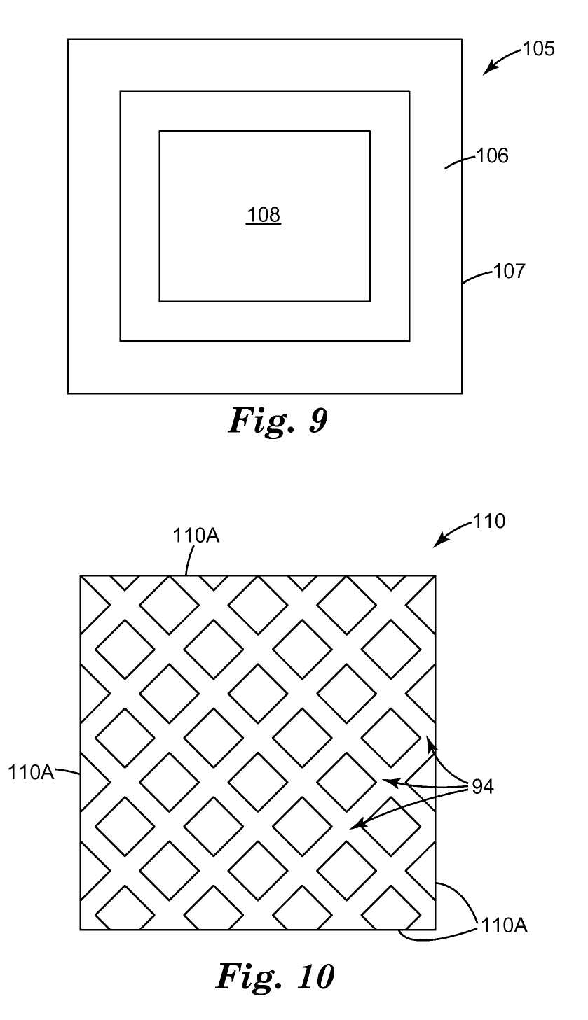

FIG. 9 is schematic perspective view of a system 105 that includes a tape that forms a printed border 106. In particular, printed border 106 defines an outer frame 107 around projection screen 108, which may help draw a visible distinction between screen 108 and an application surface on which screen 108 is placed. Border 106 also reduces the chance that a slightly misaligned projector will shine directly into the eyes of a viewer. Border 106 could be a single color or it could include graphics, characters, advertising or other printing. While border 106 is offset from screen 108 in the embodiment shown in FIG. 9, in other embodiments, border 106 may be directly adjacent to screen 108.

FIG. 10 illustrates a plan view of microreplicated adhesive layer 110 that may be used to couple a substantially flexible projection screen to an application surface. Adhesive layer 110 may be, for example, adhesive 74 of screens 60 and 80 (FIGS. 4 and 5) or adhesive 90 of screen 84 (FIG. 6). Although screen 60 is referred to throughout the description of adhesive layer 110, in other embodiments, screen 80 (FIG. 5), screen 84 (FIG. 6), screen 96 (FIG. 7), screen 100 (FIG. 8) or other projection screens including a repositionable adhesive and/or a stiffening film may also include microreplicated adhesive layer 110.

Microreplicated adhesive 110, which may also be referred to as a microstructured adhesive, exhibits certain structural characteristics that reduce and, in some cases, eliminate the subsequent formation of air pockets in screen 60 (or screen 80) after screen 60 is coupled to an application surface. Adhesion of screen 60 to an application surface or another substrate may result in entrapped air or another fluid between screen 60 and the application surface. In embodiments in which adhesion of screen 60 to an application surface is aided via a liquid, e.g., water, or another fluid placed between screen 60 and the application surface, the liquid may become entrapped between screen 60 and the application surface. Microreplicated adhesive 100, however, defines a plurality of channels 112 for the air, liquid or other fluid to traverse in order to exit the space between screen 60 and the application surface.

Channels 112 define a topography of adhesive 110 that encourages fluid bleed. Channels 112 may be continuous open pathways or grooves that extend into adhesive 110 from the exposed surface. Channels 112 either terminate at the peripheral portion 110A of adhesive layer 110 or communicate with other channels that terminate at peripheral portion 110A of adhesive layer 110. A user may “bleed” the air trapped between adhesive 110 and an application surface or another substrate via the microreplicated adhesive channels. In this way, microreplicated adhesive 110 provides a reduction or elimination of the formation of air pockets due to outgassing.

In other embodiments, microreplicated adhesive 110 may not define an ordered array of channels, as shown in FIG. 10. For example, a microreplicated adhesive may define a chaos pattern, which is a substantially random pattern of channels that terminate at peripheral portion 110A of adhesive 110 or communicate with other channels that terminate at peripheral portion 110A. Other microreplicated adhesives having regular or irregular patterns may be used in other embodiments.

The use of a release liner or backing is one method suitable for forming the microreplicated adhesive 110. The release liner or backing may be embossed with the desired microreplicated pattern, and then the adhesive may be subsequently applied to the linear via any suitable technique, such as casting, extruding, coating, spraying, screen-printing and laminating. The topography of the embossing tool(s) typically has the same topography as the microreplicated adhesive, with the liner having an inverse topography in order to replicate the image of the tool(s) on the adhesive surface. The release liner may be made of various materials such as but not limited to plastics such as polyethylene, polypropylene, polyesters, cellulose acetate, polyvinylchloride, and polyvinylidene fluoride, as well as paper or other substrates coated or laminated with such plastics. The embossable coated papers or thermoplastic films may be siliconized or otherwise treated to impart improved release characteristics. The thickness of the release liner can vary widely according to the desired effect. Furthermore, it is possible to afford structures to the release liner by using various techniques, such as those disclosed in U.S. Pat. No. 5,650,215, entitled, “PRESSURE-SENSITIVE ADHESIVES HAVING MICROSTRUCTURED SURFACES” and issued on Jun. 22, 1997, which is incorporated herein by reference in its entirety.

In other techniques for forming microreplicated adhesive 110, the microstructured surface may be embossed onto an adhesive layer. The microreplicated features may be imparted by embossing the adhesive directly through utilization of molding tools. Such methods and practices are fully disclosed in U.S. Pat. No. 5,650,215. Alternatively an inverse embossing tool may be used to directly impart the microstructures onto an adhesive surface. Microreplicated adhesive 110 may be manufactured by other means as well.

Examples of microreplicated adhesives and methods of making the same are further described in commonly-assigned U.S. Pat. No. 6,197,397, entitled, “ADHESIVES HAVING A MICROREPLICATED TOPOGRAPHY AND METHODS OF MAKING AND USING SAME” and issued on Mar. 6, 2001, PCT Publication No. WO 00/22059 (Hidetoshi), and PCT Publication No. WO 00/69985 (Mikami). The entire content of each of the U.S. Pat. No. 6,197,397 and PCT Publication Nos. WO 00/22059 and WO 00/69985 are incorporated herein by reference.

FIG. 11 is a flow diagram illustrating an embodiment of a technique for placing a screen on an application surface. While screen 60 of FIG. 4 is referred to throughout the description of FIG. 11, in other embodiments, the technique shown in FIG. 11 may be used to apply any screen described herein or any screen including a repositionable adhesive to an application surface. According to the technique shown in FIG. 11, a user may place screen 60 on an application surface (144). If the screen is at the desired position (116), such as aligned with a projector (e.g., projector 18 of FIG. 1) that will be used to present an image on screen 60 or centered with respect to the application surface, the user may apply pressure to screen 60 to engage adhesive 74 with the application surface (118). Applying pressure to screen 60 helps secure screen 60 in place on the application surface. On the other hand, if screen 60 is not correctly positioned at the desired position on the application surface, the user may slide screen 60 to another position (120). The user may continue to slide screen 60 between different positions on the application surface until the desired position is achieved. Thereafter, the user may apply pressure to screen 60 to engage adhesive 74 with the application surface (118).

Adhesion of screen 60 to the application surface may be aided by a fluid, such as water, between screen 60 and the application surface. For example, water may be applied to the application surface prior to placing screen 60 on the surface. The fluid may also decrease the coefficient of friction between screen 60 and the application surface, which may help the user slide screen 60 relative to the application surface. Upon placing screen 60 at the desired position on the application surface, the user may bleed the fluid out from between screen 60 and the application surface, such as with the aid of a microstructured topography (e.g., shown in FIG. 10) and/or a roller that applies a uniform pressure to screen 60.

The projection screens described herein are useful for many different applications. Examples of methods of providing information to a potential customer according are described in commonly-assigned U.S. Pat. No. 6,870,670, entitled, “SCREENS AND METHODS FOR DISPLAYING INFORMATION,” which was previously incorporated by reference. Also described in U.S. Pat. No. 6,870,670 are various networks that may be utilized to display information via a projection screen. Those networks may also utilize a projection system including a projection screen described herein.

Various embodiments of the invention have been described. These and other embodiments are within the scope of the following claims.

1. A method comprising:
coupling a substantially flexible projection screen to a substantially transparent surface at a first position with a repositionable adhesive, wherein the flexible screen comprises a rear surface configured to receive light from a projector, a viewing surface opposite the rear surface, and a light absorbing layer for rendering the screen substantially opaque in ambient lit conditions when no image is projected on the screen by the projector;
adjusting the screen relative to the substantially transparent surface from the first position to a second position without entirely uncoupling the flexible screen from the substantially transparent surface; and
securing the screen to the substantially transparent surface at the second position with the repositionable adhesive.

2. The method of claim 1, wherein adjusting the screen comprises sliding the screen along the substantially transparent surface from the first position to the second position.

3. The method of claim 1, wherein securing the screen to the substantially transparent surface comprises applying pressure to the screen to engage an adhesive layer of the repositionable adhesive with the substantially transparent surface.

4. The method of claim 1, further comprising projecting an image from a projector onto a rear surface of the screen to provide information to viewers.

5. The method of claim 1, further comprising removing the screen from the substantially transparent surface after a time period.

6. The method of claim 5, wherein the substantially transparent surface comprises a first substantially transparent surface, and the method further comprises coupling the screen to a second substantially transparent surface.

7. The method of claim 5, further comprising recoupling the screen to the substantially transparent surface with the repositionable adhesive.

8. The method of claim 1, wherein the screen comprises a non-holographic screen.

9. The method of claim 1, the repositionable adhesive comprises an optical adhesive.

10. The method of claim 1, wherein the screen comprises a plurality of refractive elements, a flexible light transmitting substrate, and a light absorbing layer associated with the light transmitting substrate for controlling ambient light rejection so that the screen appears substantially dark when no light is projected onto the screen from the projector.

11. The method of claim 10, wherein the screen further comprises a film comprising a greater stiffness than the light transmitting substrate.

12. The method of claim 11, wherein the film is substantially self-supporting.

13. The method of claim 11, wherein the film comprises at least one of polyvinyl chloride, acrylic, polycarbonate, polyethylene terephthalate (PET), polyethylene terephthalate glycol (PETG) or combinations of such materials.

14. The method of claim 1, wherein coupling the screen to the substantially transparent surface comprises adhering the rear or viewing surface Onto the substantially transparent surface with the repositionable adhesive.

15. A method comprising:
coupling a non-holographic, substantially flexible screen to a substantially transparent surface at a first position with a repositionable adhesive, wherein the screen comprises a rear surface for receiving light from a projector and a viewing surface opposite the rear surface;
adjusting the screen relative to the substantially transparent surface from the first position to a second position without completely uncoupling the screen from the substantially parent surface; and
securing the screen to the substantially transparent surface with the repositionable adhesive.

16. A projection screen for use in an optical system comprising a projector, the projection screen comprising:
a substantially flexible light transmitting substrate;
light absorbing means associated with the light transmitting substrate for controlling ambient light rejection so that the screen appears substantially dark in ambient lit conditions when no light is projected on the screen from the projector; and
a repositionable adhesive configured to couple the screen to a substantially transparent surface in a first position so that viewers may view the screen through the substantially transparent surface, wherein the repositionable adhesive is further configured to permit a user to move the screen from the first position to a second position, relative to the substantially transparent surface without completely uncoupling the screen from the substantially transparent surface.

17. The projection screen of claim 16, wherein the repositionable adhesive is configured to slidably couple the screen to the substantially transparent surface, such that the user may slide the screen along the substantially transparent surface from the first position to the second position.

18. The projection screen of claim 16, wherein the repositionable adhesive comprises a pressure-sensitive adhesive layer and a large number of spaced projections comprising pressure-sensitive adhesive and chimps of particles substantially uniformly distributed over and protruding from at least one surface of the pressure-sensitive adhesive layer, wherein at least the tips of the clumps of particles of the projections are substantially free from the pressure-sensitive adhesive.

19. The projection screen of claim 16, wherein the repositionable adhesive comprises a microstructured adhesive.

20. The projection screen of claim 19, wherein, the repositionable adhesive comprises a microstructured topography.

21. The projection screen of claim 16, further, comprising a plurality of refractive elements.

22. The projection screen of claim 21, wherein the plurality of refractive elements comprise glass beads.

23. The projection screen of claim 16, wherein the repositionable adhesive comprises an optical adhesive.

24. The projection screen of claim 23, wherein the optical adhesive comprises a removable adhesive.

25. The projection screen of claim 16, wherein the screen is a disposable screen that is conformable to a substantially non-planar substrate.

26. The projection screen of claim 16, wherein the screen may be readily manually cut to customize the shape of the screen.

27. The projection screen of claim 16, wherein the screen: includes a rear surface for receiving light from a projector and a viewing surface opposite the front surface, and the repositionable adhesive is situated on the viewing surface of the screen.

28. The projection screen of claim 27, wherein the repositionable adhesive is situated on substantially the entire viewing surface of the screen.

29. The projection screen of claim 16, further including a substantially opaque border.

30. The projection screen of claim 16, further comprising a film comprising a greater stiffness than the light transmitting substrate.

31. The projection screen of claim 30, wherein the film is substantially self-supporting.

32. The projection screen of claim 30, wherein the film comprises a substantially transparent and substantially flexible film.

33. The projection screen of claim 32, wherein the film comprises at least one of polyvinyl chloride, acrylic, polycarbonate, polyethylene terephthalate (BET), polyethylene terephthalate glycol (PETG) or combinations of such materials.

34. An optical system comprising:
a projector for presenting an image; and
a screen comprising a rear side for receiving light from the projector and a viewing side opposite the rear side, the screen being adapted to receive an image from the projector from the rear side of the screen and present it to a viewer from the viewing side of the screen, wherein the screen comprises:
light absorbing means for absorbing ambient light; and
a repositionable adhesive configured to couple the screen to the substantially transparent surface in a first position so that viewers may view the screen through the substantially transparent surface, wherein the repositionable adhesive is further configured to permit a user to move the screen from the first position to a second position relative to the substantially transparent surface without completely uncoupling screen from the substantially transparent surface.

35. The system of claim 34, wherein the screen comprises a front projection screen.

36. The system of claim 34, wherein the repositionable adhesive comprises a removable adhesive.

37. The system of claim 34, wherein the repositionable adhesive comprises a permanent adhesive.

38. The system of claim 34, wherein the screen is substantially flexible.

39. The system of claim 38, wherein the screen is substantially conformable to a surface on which the screen is coupled.

40. The system of claim 34, further including cutting means for cutting the screen to a customize shape.

41. The system of claim 34, further including a roller for removing bubbles encountered during installation.

42. The system of claim 34, wherein the screen comprises a rear projection screen.

43. The system of claim 34, wherein the repositionable adhesive comprises a pressure-sensitive adhesive layer and a large number of spaced projections comprising pressure-sensitive adhesive and clumps of particles substantially uniformly distributed over and protruding from at least one surface of the pressure-sensitive adhesive layer, wherein at least the tips of the clumps of particles of the projections are substantially free from the pressure-sensitive adhesive.

44. The system of claim 34, wherein the repositionable adhesive comprises a microstructured adhesive.

45. The system of claim 44, wherein the repositionable adhesive comprises a microstructured topography.

46. The system of claim 34, further comprising a film comprising a greater stiffness than the light transmitting substrate.

47. The system of claim 46, wherein the film is substantially self-supporting.

48. The system of claim 46, wherein the film comprises a substantially transparent and substantially flexible film.

49. The system of claim 48, wherein the film comprises at least one of polyvinyl chloride, acrylic, polycarbonate, polyethylene terephthalate (PET), polyethylene terephthalate glycol (PETG) or combinations of such materials.

50. A projection screen comprising:
a first surface;
a second surface opposite the first surface;
an array of refractive elements, wherein the refractive elements are substantially surrounded by an opaque matrix and exhibit a refractive index in the range of 1.4 to 2.0, and wherein the opaque matrix defines an army of apertures; and
a repositionable adhesive configured to couple the screen to an application surface in a first position, wherein the repositionable adhesive is further configured to permit a user to move the screen from the first position to a second position relative to the application surface without completely uncoupling screen from the application surface,
wherein the screen exhibits a mechanical flexibility sufficient to allow it to be rolled up into a cylindrical roll having an inner diameter of 15.25 centimeters (6 inches) or less, and an attachment member associated with at least one of said first and said second sides of said screen.

51. The screen of claim 50, wherein the refractive index is in the range of 1.5 to 1.8.

52. The screen of claim 51, wherein the refractive index is in the range of 1.6 to 1.7.

53. The screen of claim 50, wherein the refractive elements comprise microspheres.

54. The screen of claim 50, wherein the refractive elements comprise glass heads.

55. The screen of claim 50, wherein the ambient light contrast ratio of the screen is greater than 25.

56. The screen of claim 50, wherein the repositionable adhesive comprises a pressure-sensitive adhesive layer and a large number of spaced projections comprising pressure-sensitive adhesive and clumps of particles substantially uniformly distributed over and protruding from at least one surface of the pressure-sensitive adhesive layer, wherein at least the tips of the chimps of particles of the projections are substantially free from the pressure-sensitive adhesive.

57. The screen of claim 50, wherein the repositionable adhesive comprises a microstructured adhesive.

58. The screen of claim 57, wherein the repositionable adhesive comprises a microstructured topography.

59. The screen of claim 50, further comprising a light transmitting substrate and a film comprising a greater stiffness than the light transmitting substrate.

60. The screen of claim 59, wherein the film is substantially self-supporting.

61. The screen of claim 59, wherein the film comprises a substantially transparent and substantially flexible film.

62. The screen of claim 61, wherein the film comprises at least one of polyvinyl chloride, acrylic, polycarbonate, polyethylene terephthalate (PET), polyethylene terephthalate glycol (PETG) or combinations of such materials.

63. A method comprising:
selecting an application surface for application of a substantially flexible projection screen, wherein the projection screen comprises
a substantially flexible light transmitting substrate;
light absorbing means associated with the light transmitting substrate for controlling ambient light rejection so that the screen appears substantially dark in ambient lit conditions when no light is projected on the screen from the projector;
a substantially flexible film comprising a stiffness greater than the substantially flexible light transmitting substrate; and
an adhesive configured to couple the screen to the application surface; and
coupling the projection screen to the application surface with the adhesive.

64. The method of claim 63, further comprising projecting an image from a projector onto the rear surface of the screen to provide the information to the viewers.

65. The method of claim 63, wherein the adhesive comprises a removable adhesive.

66. The method of claim 63, wherein the adhesive comprises a repositionable adhesive, the method further comprising initially placing the projection screen on the application surface at a first position, and adjusting the screen relative to the application surface from the first position to a second position without completely removing the projection screen from the substantially transparent surface, wherein coupling the projection screen to the application surface with the adhesive comprises securing the screen to the substantially transparent surface at the second position with the adhesive.

67. A projection screen comprising:
a substantially flexible light transmitting substrate;
light absorbing means associated with the light transmitting substrate for controlling ambient light rejection so that the screen appears substantially dark in ambient lit conditions when no light is projected on the screen from the projector;
a substantially flexible film comprising a stiffness greater than the substantially flexible light transmitting substrate; and
an adhesive configured to couple the screen to an application surface.

68. The projection screen of claim 67, wherein the adhesive comprises a removable adhesive.

69. The projections screen of claim 67, wherein the adhesive comprises a repositionable adhesive configured to couple the screen to the application surface in a first position and permit a user to move the screen from the first position to a second position relative to the application surface without completely uncoupling screen from the application surface.

70. The projection screen of claim 69, wherein the repositionable adhesive is configured to permit the user to slide the screen along the substantially transparent surface from the first position to the second position.

71. The projection screen of claim 69, wherein the repositionable adhesive comprises a pressure-sensitive adhesive layer and a large number of spaced projections comprising pressure-sensitive adhesive and clumps of particles substantially uniformly distributed over and protruding from at least one surface of the pressure-sensitive adhesive layer, wherein at least the tips of the clumps of particles of the projections are substantially free from the pressure-sensitive adhesive.

72. The projection screen of claim 69, wherein the repositionable adhesive comprises a microstructured adhesive.

73. The projection screen of claim 67, wherein the adhesive comprises a microstructured topography.

74. The projection screen of claim 67, wherein the film is substantially self-supporting.

75. The projection screen of claim 67, wherein the film comprises a substantially transparent film.

76. The projection screen of claim 75, wherein the film comprises at least one of polyvinyl chloride, acrylic, polycarbonate, polyethylene terephthalate (PET), polyethylene terephthalate glycol (PETG) or combinations of such materials.

77. The projection screen of claim 67, further comprising a plurality of refractive elements.

78. The projection screen of claim 77, wherein the plurality of refractive elements comprise glass beads.

79. The projection screen of claim 67, wherein the adhesive comprises an optical adhesive.

80. The projection screen of claim 67, wherein the screw is a disposable screen that is conformable to a substantially non-planar substrate.

81. The projection screen of claim 67, wherein the screen may be readily manually cut to customize the shape of the screen.

82. The projection screen of claim 67, wherein the screen includes a rear surface for receiving light from a projector and a viewing surface opposite the front surface, and the adhesive is situated on the viewing surface of the screen.

83. The projection screen of claim 82, wherein the adhesive is situated on substantially the entire viewing surface of the screen.

84. An optical system comprising:
a projector for presenting an image;
a screen comprising a rear side for receiving light from the projector and a viewing side opposite the rear side, the screen being adapted to receive an image from the projector from the rear side of the screen and present it to a viewer from the viewing side of the screen, wherein the screen comprises:
a substantially flexible light transmitting substrate;
light absorbing means associated with the light transmitting substrate for controlling ambient light rejection so that the screen appears substantially dark in ambient lit conditions when no light is projected on the screen from the projector;
a substantially flexible film comprising a stiffness greater than the substantially flexible light transmitting substrate; and
an adhesive configured to couple the screen to an application surface.

85. A projection screen, comprising:
a first surface;
a second surface opposite the first surface;
an array of refractive elements, wherein the refractive elements are substantially surrounded by an opaque matrix and exhibit a refractive index in the range of 1.4 to 2.0, and wherein the opaque matrix defines an army of apertures;
a substantially flexible light transmitting substrate; and
a substantially flexible film comprising a stiffness greater than the substantially flexible light transmitting substrate, wherein the light transmitting substrate is positioned between the array of refractive elements and the film,
wherein the screen exhibits a mechanical flexibility sufficient to allow it to be rolled up into a cylindrical roll having an inner diameter of 15.25 centimeters (6 inches) or less, and an attachment member associated with at least one of said first and said second sides of said screen.
